(19) United States
(12) Patent Application Publication
(10) Pub. No.: US 2014/0025441 A1
(43) Pub. Date: Jan. 23, 2014

(54) PEER SUPPORT GAMIFICATION BY APPLICATION KNOWLEDGE SCORING IN SOCIAL NETWORKS

(71) Applicants: Peter Eberlein, Malsch (DE); Bare Said, Sankt Leon-ROT (DE)

(72) Inventors: Peter Eberlein, Malsch (DE); Bare Said, Sankt Leon-ROT (DE)

(73) Assignee: SAP AG, Walldorf (DE)

(21) Appl. No.: 13/553,254

(22) Filed: Jul. 19, 2012

(51) Int. Cl. G06Q 10/06

(52) U.S. Cl. 705/7.39

(57) ABSTRACT

A computer-implemented method tracks users' operation of individual components of a business application over time and stores tracking data on ways in which different users operate individual components of the business application in a user history database. The method further includes evaluating the stored tracking data in the user history database to determine each user's knowledge and proficiency in operating a particular component of the business application, and accordingly, assigning a proficiency score to each user for knowledge and proficiency in operating the particular component of the business application.

### BACKGROUND

An application is a term used in computing to define a software program or group of programs that perform a function. A business application is software that carries out a business function such as, for example, accounting or payroll. Business applications are used to increase productivity, to measure productivity and to perform business functions accurately.

For home or small office use, business applications may, for example, include home accounting software, and office suites for word processing, spreadsheets, presentations, graphics, and databases. For medium size office or business use, business applications may, for example, include applications in the fields of accounting, groupware, customer relationship management, human resources software, outsourcing relationship management, loan origination software, shopping cart software, and field service software. For large businesses or enterprise use, business applications may, for example, include applications in the fields of enterprise resource planning, enterprise content management (ECM), business process management (BPM) and product lifecycle management. Business applications can be extensive in scope, and often come with modules that either add native functions or incorporate the functionality of third-party software programs. Business applications may be installed either on desktops or on big servers. Business applications can have interactive user-application interfaces. Users may be able to query, modify, input or enter data and view results via the interactive user-application interfaces.

Modem business applications, whether built in-house or bought from vendors (off the shelf software products), are large complex products. The business application products may be accompanied by extensive technical documentation and large manuals, which in practice are often too complex or arcane for users of the products to peruse or understand. Users need extensive (and expensive) training to be able to use these complex products. However, even experienced or trained users of these business application products often encounter difficulties and situations in which they do not know how to properly use features or components of these products. Knowledge about using these features or components may be too specialized. If the users are unable to find answers to questions about the features or components of the business application products on their own, they may have to rely on technical support from the product vendors. To answer user questions, vendors may have to provide specialized technical support, around the clock, and often across different time zones in which the products may be used. From a product vendor's perspective, specialized technical support, apart from adding to costs, is difficult to staff or provide. In practice, from the user's perspective, technical support from product vendors, even if available, is often time-consuming, difficult, unreliable and frustrating to get. Users often are on their own, or have to rely on informal support from non-specialist co-workers or friends, to get answers to their questions about the features or components of the business application products.

Consideration is now being given to ways of enabling users to gain knowledge of the features or components of the business applications in a practical and effective manner.

### SUMMARY

A process for providing technical support to users of a business application is based on knowledge and expertise sharing by peer users. Upon user opt-in or permission, user-application interactions are monitored and tracked over time. The tracking data can show, for example, how often, how quickly and how error-free a user operates a particular component of the business application. Users with superior knowledge and expertise in operating the particular component of the business application are identified by analysis of the tracking data. These users can be voluntarily identified as experts on a social network of peer users and may be available to help other users with answers to questions about the business application.

In a general aspect, a computer-based system allows subscribing users to share knowledge on operating components of a business application with their peers. The system includes an application usage recorder, a user history database and a scoring unit. The application usage recorder is configured to track, over time, users' operation of individual components of the business application and log tracking data on ways in which different users operate individual components of the business application over time in the user history database. The scoring unit is configured to evaluate the tracking data stored in the user history database to determine each user's knowledge and proficiency in operating a particular component of the business application and to accordingly assign a proficiency score to each user for knowledge and proficiency in operating the particular component of the business application.

It will be understood that the computer-based system may track a user's operation of the business application, and store, analyze, share or publish any user data only with the user's consent or permission. Suitable authorization procedures may be deployed get the user's express permission or opt-in consent. For example, the business application may include settings or controls by which users can control tracking, storing, analyzing, sharing or publishing of their data. The controls may, for example, be hosted within or directly linked from the application, or separately presented on a user-interface by the computer system. The authorization procedures may include a mechanism by which the user can later opt out or rescind permissions.

The computer-based system is implemented by instructions recorded on a non-transitory computer readable storage medium and executable by at least one processor

In a social network related aspect, the scoring unit of the computer-based system is configured to publish the users' proficiency scores for knowledge and proficiency in operating the particular component of the business application on a social network. In another social network related aspect, the scoring unit is configured to employ a gamification technique on the social network to motivate users to gain expert status in operating components of the business application.

In another aspect, the computer-based system includes a score reporting unit, which is configured to append the users' proficiency scores for knowledge and proficiency in operating the particular component of the business application to searchable user profiles on a social network.

In another aspect, the computer-based system includes an expert finder unit configured to search user profiles on the social network by proficiency score to identify one or more experts with knowledge and proficiency in operating the particular component of the business application.

In a general aspect, a computer-implemented method involves tracking over time users' operation of individual components of a business application, and storing tracking data over time on ways in which different users operate individual components of the business application in a user history database. The method further involves evaluating the stored tracking data in the user history database to determine each user's knowledge and proficiency in operating a particular component of the business application, and accordingly assigning a proficiency score to each user for knowledge and proficiency in operating the particular component of the business application. In another aspect, the method involves publishing the users' proficiency scores for knowledge and proficiency in operating the particular component of the business application on a social network. In another aspect, the method employs a gamification technique on the social network to motivate users to increase their proficiency scores for knowledge and proficiency in operating components of the business application. In yet another aspect, the method involves searching searchable user profiles by proficiency score to identify one or more expert users with knowledge and proficiency in operating the particular component of the business application. These expert users may be available to help answer questions from other users about the particular component of the business application.

The foregoing computer-implemented method is carried out by causing at least one processor to execute instructions recorded on a computer-readable storage medium,

In a general aspect, a computer program product embodied in non-transitory computer-readable media includes executable code, which code when executed tracks over time users' operation of individual components of a business application and stores tracking data on ways in which different users operate individual components of the business application. Further, the code when executed evaluates the stored tracking data to determine each user's knowledge and proficiency in operating a particular component of the business application and accordingly, assigns a proficiency score to each user for knowledge and proficiency in operating the particular component of the business application.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustration of an example computer-based system for users to share knowledge on components of a business application with their peers, in accordance with principles of the disclosure herein.

FIG. 2 is a flow diagram illustration of an example method for providing peer support to users of a business applications who need help with operating components of a business application, in accordance with principles of the disclosure herein.

### DETAILED DESCRIPTION

A process for enabling a user to gain knowledge to use or operate functions, features or components (“components”) of a business application in a practical and effective manner involves sharing knowledge available in a community of users of the business application. The process establishes a pool of “expert” users who may have specialized knowledge or expertise about individual components of the business applications. A social network may be utilized to connect the community of users of the business application. The pool of expert users may be made available over the social network to help other users. Individual members of the pool of expert users may be respectively associated with the particular components of the business application they have specialized knowledge or expertise in. A user seeking an answer to a question about a particular feature or component of the business application can seek help from the expert member of the pool associated with that particular feature or component.

Membership in the pool of expert users may be based on demonstrated knowledge or proficiency of a candidate user in interacting with or operating a particular individual feature or component of a business application. All user interactions with the business application may be automatically monitored and logged. The proficiency or knowledge of a user may be quantitatively assessed and scored by evaluating user interactions with the business application. As the user operates a particular individual feature or component of the business application, an assessment can be made of the quality of the user's interaction. For example, a spreadsheet application may have a feature for entering a mathematical formula in a cell of the spreadsheet. By entering a mathematical formula in the spreadsheet application, the user demonstrates his or her knowledge of the feature. An assessment can be made if the user enters the mathematical formula in the spreadsheet properly, how quickly, and in how many attempts. Based on this assessment, a quantitative score can be assigned to the users' knowledge and proficiency in using the mathematical formula feature of the spreadsheet application. Similarly, a business warehouse application may have a query feature for generating reports. By entering query parameters for generating a report, a user may demonstrate his or her knowledge of the feature. Based on an assessment of the user's success in properly entering query parameters to generate a report, a score can be assigned to the users' knowledge and proficiency in operating the query feature of the business warehouse application.

User interactions with a business application (or system of applications) may be monitored and logged for each feature or component of the business application. A “proficiency” score may be assigned to a user for each feature or component of the business application used. The proficiency scores may be based on a quantitative scoring scheme. The scoring scheme may, for example, assign a higher score to a user who uses a feature or component of the business application correctly in one attempt than the score assigned to a user who requires multiple trial-and-error cycles to use the feature or component correctly. The proficiency score assigned to a user may be updated each time the user interacts with the feature or component. Repeating an operation for a feature or component again after several days or weeks demonstrates that the user still remembers the correct operation. The proficiency score assigned to the user for knowledge and proficiency in the feature or component of the business application may be accordingly increased.

User proficiency scores for components of the business application may be reported to a social network. The social network may be a social network that is open to the general public (e.g., Facebook), a quasi-public social network that is open only to limited public groups (e.g., a group of professionals such as accountants), or a private social network that is open only to private groups (e.g. company's employees). Users with high proficiency scores may be accorded expert status and designated as expert users. Publishing the user proficiency scores and identifying users with expert status on the social network may create social reputations for the expert users. Users may become motivated to master operations of components of the business application to improve their scores to gain expert status or to enhance their social reputations if they already have expert status.

With a goal of increasing a population of expert users, gamification techniques may be employed on the social network to motivate users to gain expert status in features and components of the business application. Gamification elements such as badges, rewards, trophies, leaderboards and ribbons may be used to motivate users to gain expert status by taking advantage of humans' psychological predisposition to engage in gaming. The gamification elements may be awarded to users based on their scores for knowledge and proficiency in components of the business application. Users may be motivated by award of the gamification elements to practice and master operation of the features and components of the business application to increase their proficiency scores, become experts, or enhance their social reputations if they already have expert status. Further, similar gamification techniques may be used to motivate or encourage users with expert status to take time to actually provide peer support to other users who are in need of help.

The user proficiency scores published on the social network may be searchable. A user seeking expert help with a feature or component of the business application, may be able to use “score” as a search criterion to identify a list of one or more expert users on the social network with specialized knowledge or expertise. These experts may be able to provide the expert help sought by the help-seeking user. The help-seeking user may contact an expert on the list for help. If the expert is not available immediately or quickly for any reason, the help-seeking user may contact any other expert on the list for help. The social network may also allow a user may establish a personal network of social connections with others. An expert who is socially connected to the help-seeking user may be more inclined to help the user or answer questions from the user than an expert who is not. By getting help from expert users identified on the social network, the help-seeking user may be able to avoid requesting support from the vendor of the business application.

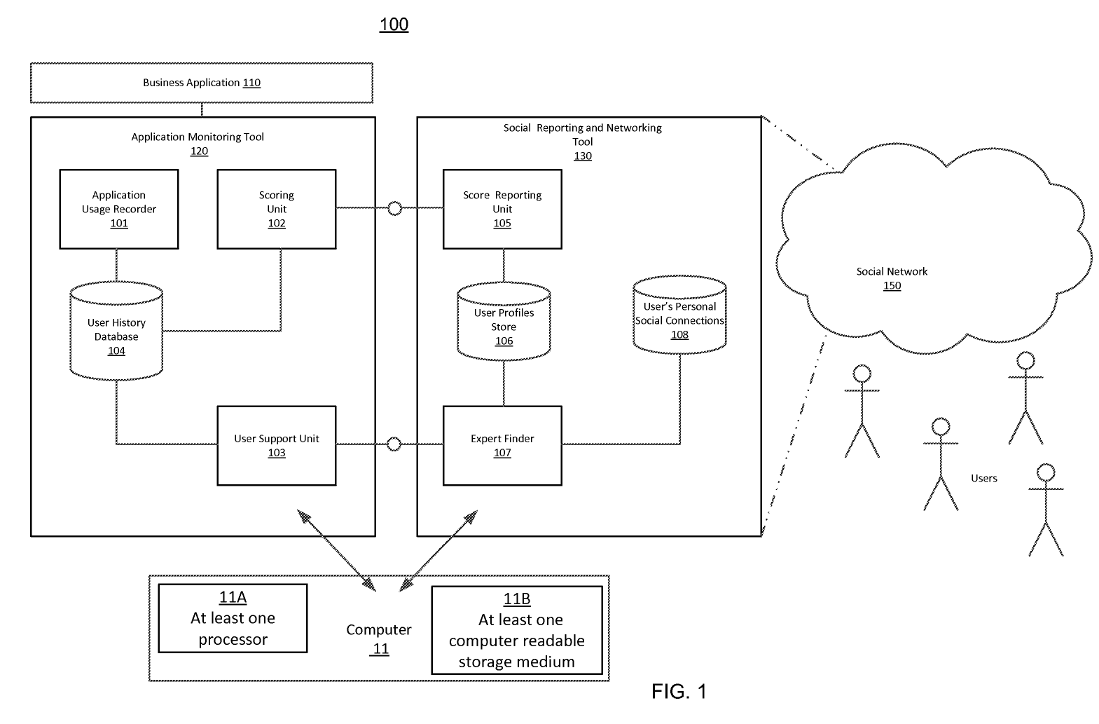

FIG. 1 shows an example computer-based system 100 for users to share knowledge on components of a business application with their peers, in accordance with principles of the disclosure herein. System 100 may be deployed to support a community of users of the business application (e.g., business application 110) who may subscribe to a social network (e.g. social network 150). System 100, like business application 110 itself, may be deployed on one or more physical or virtual hosts in a computer network.

In the example configuration shown in FIG. 1, system 100 includes an application monitoring tool 120 coupled to a social networking tool 130, which may be a component or plug-in of a social networking solution (e.g., social network 150). Application monitoring tool 120 may include an application usage recorder 101, a scoring unit 102, and a user support unit 103. Application monitoring tool 120 may also include or be coupled to one or more data stores (e.g., user history database 104). Social networking tool 130 may include a score reporting unit 105 and an expert finder unit 107. Social networking tool 130 may also include or be coupled to one or more data stores (e.g., user profiles 106 and user's personal social connections 108).

In various implementations or configurations of system 100, components (e.g., 101-108) may be included in or attached to business application 110 itself. It will be understood that the particular configuration of system 100 as application monitoring tool 120 and social networking tool 130, and the particular distribution of various components (e.g., 101-108) between the two tools, shown in FIG. 1, is only for example. In various practical implementations of system 100, application monitoring tool 120 and social networking tool 130 may be merged as one unit or have a different distribution of components (e.g., 101-108) between them. For example, in a standalone desktop application configuration, user history database 104 may be embedded in business application 110 itself. In contrast, in a client/server application configuration, user history database 104 may be hosted on the server side, and coupled, for example, to user profiles store 106 on the server side.

As noted previously, system 100, like business application 110 itself, may be deployed on one or more physical or virtual hosts in a computer network. In the example of FIG. 1, system 100 (including components 101-108), along with business application 110 and social network 150, is illustrated as executing in the context of at least one computer 11. As shown, and as would be appreciated, the at least computer 11 may include or utilize at least one processor 11A, as well as at least one computer readable storage medium 11B. Of course, the at least one processor 11A and the computer readable storage medium 11B may be understood to represent or include any known or future examples of corresponding components that may be utilized in the context of the at least one computer 11. Further, it may be appreciated that any additional, or otherwise conventional, components may be utilized in the context of the at least one computer 111, including, for example, components related to power, communications, input/output functions, network connections and other conventional features and functions that would be understood by one of skill in the art to be potentially implemented in the context of the at least one computer 11.

Moreover, although the at least one computing device 11 is illustrated in the example of FIG. 1 as a single computer, it may be understood that the at least one computer 11 may represent two or more computers in communication with one another. Therefore, it will also be appreciated that any two or more components 101-108 of system 100 may similarly be executed using some or all of the two or more computing devices in communication with one another. Conversely, it also may be appreciated that various components illustrated as being external to the at least one computer 11 may actually be implemented therewith.

The components (101-108) of application monitoring tool 120 and social networking tool 130 of system 100 are described below, generally in numeric sequence. However, it is noted that user support unit 103 of application monitoring tool 120, which may be coupled to expert finder 107 of social networking tool 130, is described after a description of expert finder 107 herein.

In operation, users may interact with business application 110 and operate components of the application via a user-application interface (not shown). Application monitoring tool 120 may be deployed to monitor the user interactions with business application 110.

### Application Usage Recorder

Application usage recorder 101 in application monitoring tool 120 may be configured to listen in all user interactions with the business application 110. In particular, application usage recorder 101 may track how each user operates individual components of the business application 110. Application usage recorder 101 may monitor errors or error messages generated in business application 110, for example, due to incorrect user input or improper operation of a feature of component of the business application 110. Application usage recorder 101 may determine if a particular user input or operation of a feature or component of the business application 110 by the user was successful or not successful. Application usage recorder 101 may log or store some or all of its tracking data on user interactions with business application 110 over time in a data store (e.g., user history database 104). The logged data may include a record of all user-interactions with business application 110, which may be indexed, for example, by feature or component of the application and by user. In particular, the logged data may include user history records for each user. The user history records may include tracking data (e.g., correct inputs, errors, number of attempts, successful generation of query reports, etc.) that can be used to assess a user's knowledge or proficiency in operating a particular feature or component of the business application 110.

In certain implementations of system 100, application usage recorder 101 may log or store some or all of its tracking data on user interactions with business application 110 in aggregated form or in cumulative time record form in user history database 104. For example, instead of logging ten separate entries for ten repeat operations of a particular query by a user over a time period (e.g., 30 minutes), application usage recorder 101 may store a single cumulative time record identifying the operation (the particular query), the number of executions (10) and the time period (30 minutes). The number and time entries in cumulative time record in user history database 104 may be updated by application usage recorder 101 over time. For example, the cumulative time record may be updated to note aggregation of data over different time frames (e.g. 6 operations this morning and 9 this afternoon, 140 operations last month, etc.). Storing or logging the data in aggregated or cumulative time record form may help limit a size of user history database 104 in implementations of system 100.

### Scoring Unit

In system 100, scoring unit 102 may be configured to assign a “proficiency” score to a user for knowledge or proficiency in operating a particular feature or component of the business application 110. The proficiency score assigned by scoring unit 102 to a user for a particular feature or component of the business application 110 may be based on quantitative criteria (e.g., the number of times the user operated the particular feature or component, over what period of time were the operations performed, the number of successful operations, the number of failed attempts or retries, etc.). Scoring unit 102 may evaluate data that is stored in user history database 104 to determine a user's knowledge or proficiency in operating a particular feature or component of the business application 110. Evaluation of the data by scoring unit 102 may be an asynchronous process, with the evaluation being conducted at suitable time intervals or on a pre-set schedule (e.g., daily, weekly, etc.). The process for evaluation of data by scoring unit 102 may benefit from the data being stored in aggregated or cumulative time record form in user history database 104 as only a few records may have to be read for each time.

Scoring unit 102 may keep a record of the proficiency score assigned to a user for a particular feature or component of the business application 110 (e.g., in user history database 104). Further, scoring unit 102 may be configured to update the proficiency score assigned to the user for the particular feature or component of the business application 110 periodically or whenever appropriate by evaluating updates or changes to the associated data or cumulative time records in user history database 104.

Scoring unit 102 may also be configured to publish the proficiency score assigned to the user for the particular feature or component of the business application 110 on social network 150. Scoring unit 102 may, for example, report the proficiency score to score reporting unit 105, which in FIG. 1 is shown as a part of social reporting and networking tool 130 on social network 150.

### Score Reporting Unit

In system 100, score reporting unit 105 may be configured to receive user proficiency scores from scoring unit 102. In system 100, score reporting unit 105 may be installed, for example, as an add-on to a social network (e.g., social network 150). Score reporting unit 105 may, additionally or alternatively, be embedded in a backend of a client/server business system if that system supports social network functionality. Scoring unit 102 may report the proficiency score to score reporting unit 105 as a local backend call if both scoring unit 102 and score reporting unit 105 are hosted on a same backend of a client/server business system. If scoring unit 102 and score reporting unit 105 are not hosted on the same backend, the backend call may be a remote call (e.g., using web services).

Score reporting unit 105 may be configured to persist or store the reported the proficiency score assigned to the user for the particular feature or component of the business application 110, for example, in user profiles store 106. User profiles store 106 may be an existing user profiles database or store in social network 150. In connection with implementation of system 100, properties or formats of the existing user profiles database or store in social network 150 may be extended to allow for inclusion of the reported proficiency scores in user profiles. User profiles store 106 properties or formats may be extended to include only a current or a most recent score in a user profile. User profiles store 106 properties need not be extended to include a historical score value in the user profile, as the historical score value may not be of relevance.

Score reporting unit 105 may be configured to publish the reported proficiency score assigned to the user for the particular feature or component of the business application 110 on social network 150. Score reporting unit 105 may be configured to publish the reported proficiency scores, for example, as “user activities”, so that they may be visible to followers of the user on social network 150. A user with a score greater than a certain value may be designated as an expert and published at such on social network 150.

With reference to FIG. 1, social reporting and networking tool 130 is shown, for example, as including further components i.e. user's personal social connections 108 and an expert finder 107. These are described below in the context of deploying system 100 by users to share knowledge on components of the business application.

### User's Personal Social Connections

User's personal social connections 108 may be a store which keeps track of connections on social network 150 established between a user (of business application 110) and other social network members. In common or popular social networks, a member may establish a connection with another member by employing techniques such as “following” the other member or designating the other member as a “friend.” The same or similar techniques may be employed by users here to establish connections on social network 150. When system 100 is deployed to support users of business application 110 in a company or business organization, connections between various users or members of social network 150 may be established by default, based on the organizational structure of the company or business organization. For example, all personnel in a department of the company or business organization may be connected by default, and each user's default connections recorded in user's personal social connections 108.

In the context of deploying system 100 so that users can share knowledge on components of the business application with peers, social reporting and networking tool 130 may include functionality (e.g., expert finder 107) to identify expert users. Expert finder 107 may be available to a user who needs help with a particular feature or component of the business application 110 via a user interface of the application (e.g., via a “help” function on the interface), via application support unit 103, or via social network 150.

Expert finder 107 may be configured to identify expert users who knowledgeable about a particular feature or component of the business application 110 and who may be able to help the help-seeking user with the particular feature or component. For this purpose, expert finder 107 may be linked to and configured to interrogate or query user profiles store 106 and user's personal social connections 108 to identify experts based on their proficiency scores for expertise in the particular feature or component of the business application 110. Expert finder 107 may prepare a list of one or more experts with expertise in the particular feature or component of the business application 110 based, for example, on the proficiency scores associated with user profiles in user profiles store 106 or published on social network 150. Expert finder 107 may rank the experts identified in the list using proficiency scores and other criteria. The other criteria may include criteria related, for example, to the availability of the experts or the ease with which the help-seeking user may be expected to contact and get help from the experts. The criteria for the ease with which the help-seeking user may be expected to contact and get help from the experts may, for example, include a measure of how closely the help-seeking user is connected to the expert on social network 150 (e.g., whether the connection is direct or indirect via one or more users). Other criteria may, for example, include a measure of physical distance (e.g., whether the help-seeking user and the expert are located in a same company building, same campus, same city or same country), and time zone differences between the help-seeking user and the expert's locations.

Expert finder 107 may be configured to present the ranked list of the experts (or the most highly ranked experts) to the help-seeking user over social network 150 or via the user interface of application 110. The user may select and contact an expert on the list for help, for example, by sending a peer support request to the expert on social network 150 or through other channels (e.g. company e-mail, phone call, face-to-face meeting, etc.).

### User Support Unit

Application monitoring tool 120 may include user support unit 103 to provide automated support to the user in operating business application 110.

Application monitoring tool 120 may be configured so that user support unit 103 is activated automatically when application monitoring tool 120 determines that the user needs help, for example, because of repeated or consistent failure to operate a function or component of application 110 properly. User history database 104, as described above, may include tracking data on successful and unsuccessful user operations and errors over time. Application monitoring tool 120/scoring unit 102/user support unit 103 may tap into user history database 104 and evaluate the tracking data therein to find repeated or consistent failure of the user over time to operate the feature or component of application 110 properly. Application monitoring tool 120 may activate user support unit 103 accordingly. User support unit 103 may be configured, in response, to suggest (e.g., on the user-application interface) to the user to seek expert help. User support unit 103 may be further configured to automatically communicate information about the particular feature or component of application 110 and other information (e.g., user identification (ID)) to expert finder 107 with a request for a list of experts who may be available help the user. User support unit 103 (or expert finder 107 directly) may present a ranked list of such experts prepared by expert finder 107 to the user on the user interface of application 110. The user may select and contact an expert on the list for help, for example, by sending a peer support request to the expert over social network 150 or other channels.

Application monitoring tool 120 may also be configured so that user support unit 103, which may be linked to expert finder 107, can be activated by an explicit user request for help (e.g., using a help function on the user-application interface).

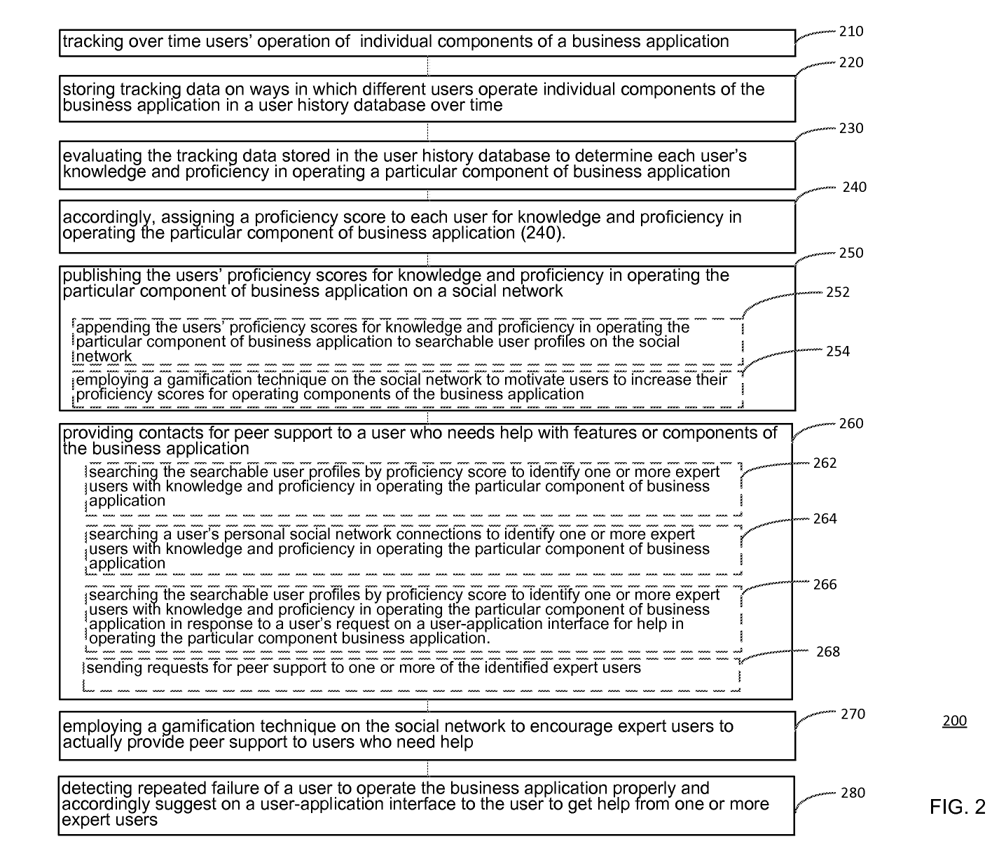

FIG. 2 shows an example method 200 for providing peer support to users of a business application who need help with operating components of the business application. Method 200 includes tracking over time users' operation of individual components of a business application (210) and storing tracking data on ways in which different users operate individual components of the business application over time in a user history database (220). Method 200 further involves evaluating the tracking data stored in the user history database to assess or determine each user's knowledge and proficiency in operating a particular component of the business application (230), and accordingly, assigning a proficiency score to each user for knowledge and proficiency in operating the particular component of the business application (240).

Method 200 also involves publishing the users' proficiency scores for knowledge and proficiency in operating the particular component of the business application on a social network (250). Publishing the users' proficiency scores 250 may include appending the users' proficiency scores for knowledge and proficiency in operating the particular component of the business application to searchable user profiles on the social network (252). Method 200 may also employ a gamification technique on the social network to motivate users to increase their proficiency scores for operating components of the business application (254).

Further aspects of method 200 may relate to identifying expert users who can provide peer support to a user who needs help with a particular component of the business application (260). These aspects may include searching the searchable user profiles (e.g., user profiles store 106) by proficiency score to identify one or more expert users with knowledge and proficiency in operating the particular component of the business application (262) and searching a user's personal social network connections to identify one or more expert users with knowledge and proficiency in operating the particular component of the business application (264).

The aspects of method 200 (e.g., 262 and 264) relating to identifying expert users who can provide peer support to a user may be activated in response to a user's request on a user-application interface for help in operating the particular component business application (266). Method 200 may also include sending requests for peer support to one or more of the identified expert users (268). The one or more of the identified expert users to whom the requests are sent may be selected by the user, or may be selected automatically using criteria such as proficiency scores, distance, etc.

Method 200 may also include employing a gamification technique on the social network to encourage expert users to actually provide peer support to users who need help (270). Gamification elements (e.g., points, trophies, badges, rank or status, etc.) may be awarded to the experts depending, for example, on the number of occasions they help their peers.

Further, method 200 may also include detecting repeated failure of a user to operate the business application properly and accordingly suggesting to the user to seek help from one or more expert users (280) on how to operate the business application properly. Method 200 may generate and provide, on a user-application interface, a notification to the user to seek help.

The various infrastructure, systems, techniques, and methods described herein may be implemented in digital electronic circuitry, or in computer hardware, firmware, software, or in combinations of them. The implementations may be a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

1. A computer-based system implemented by instructions recorded on a non-transitory computer readable storage medium and executable by at least one processor, the computer-based system comprising:
an application usage recorder;
a user history database;
a scoring unit; and
an expert finder unit,
wherein the application usage recorder is configured to track over time users' operation of individual components of a business application and store tracking data on ways in which different users operate individual components of the business application over time in the user history database,
wherein the scoring unit is configured to evaluate the tracking data stored in the user history database to determine each user's knowledge and proficiency in operating a particular component of the business application and accordingly assign a proficiency score to each user for knowledge and proficiency in operating the particular component of the business application, and
wherein the expert finder unit is configured to identify at least one expert who can provide peer support to a particular user in operating the particular component business application based on criteria including one or more of (1) an immediate availability of the expert, (2) ease with which the particular user is expected to contact and get help from the expert, (3) a measure of how closely the particular user is connected to the expert on a social network, (4) whether the connection is direct or indirect via one or more other users, (5) a measure of a physical distance between the particular user and the expert, (6) whether the particular user and the expert are located in a same company building, same campus, same city or same country, and (7) time zone differences between the particular user and the expert's locations.

2. The computer-based system of claim 1, wherein the expert finder unit is configured to present a ranked list of experts who can provide peer support to the particular user in operating the particular component business application.

3. The computer-based system of claim 2, wherein the scoring unit is configured to employ a gamification technique on the social network to award gamification elements including one or more of badges, rewards, trophies, leaderboards and ribbons to experts who actually provide peer support to users who need help.

4. The computer-based system of claim 2, wherein the expert finder unit is configured send a request for peer support to one or more experts, wherein the one or more of experts to whom the requests are sent are selected automatically using criteria including one or more of their proficiency scores, availability and distance.

5. The computer-based system of claim 4, wherein the expert finder unit is configured to search the searchable user profiles by proficiency score to identify one or more experts with knowledge and proficiency in operating the particular component of the business application.

6. The computer-based system of claim 5, further comprising, a user's personal social network connections unit that records personal connections of the user with other users on the social network.

7. The computer-based system of claim 6, wherein the expert finder unit is configured to search the user's personal social network connections unit to identify one or more experts in the user's personal social network with knowledge and proficiency in operating the particular component of the business application.

8. The computer-based system of claim 5, further comprising, a user support unit configured to detect repeated failure of a user to operate the business application properly and accordingly, generate and provide a notification to the user to seek help.

9. The computer-based system of claim 5, further comprising a user support unit that is configured to activate the expert finder unit upon a user request for help in operating a component of the business application.

10. A computer-implemented method carried out by causing at least one processor to execute instructions recorded on a computer-readable storage medium, the computer-implemented method comprising:
tracking over time users' operation of individual components of a business application;
storing tracking data on ways in which different users operate individual components of the business application over time in a user history database;
evaluating the tracking data stored in the user history database to determine each user's knowledge and proficiency in operating a particular component of the business application;
assigning a proficiency score to each user for knowledge and proficiency in operating the particular component of the business application; and
identifying at least one expert who can provide peer support to a particular user in operating the particular component business application based on criteria including one or more of (1) an immediate availability of the expert, (2) ease with which the particular user is expected to contact and get help from the expert, (3) a measure of how closely the articular user is connected to the expert on a social network, (4) whether the connection is direct or indirect via one or more users, (5) a measure of a physical distance between the particular user and the expert, (6) whether the particular user and the expert are located in a same company building, same campus, same city or same country, and (7) time zone differences between the particular user and the expert's locations.

11. The computer-implemented method of claim 10, further comprising presenting a ranked list of experts who can provide peer support to the particular user in operating the particular component business application.

12. The computer-implemented method of claim 11, further comprising employing a gamification technique on the social network to award gamification elements including one or more of badges, rewards, trophies, leaderboards and ribbons to experts who actually provide peer support to users who need help.

13. The computer-implemented method claim 11, further comprising sending a request for peer support to one or more experts, wherein the one or more experts to whom the requests are sent are selected automatically using criteria including one or more of their proficiency scores, availability and distance.

14. The computer-implemented method of claim 13, further comprising, searching the searchable user profiles by proficiency score to identify one or more expert users with knowledge and proficiency in operating the particular component of the business application.

15. The computer-implemented method of claim 14, further comprising, searching a user's personal social network connections to identify one or more expert users with knowledge and proficiency in operating the particular component of the business application.

16. The computer-implemented method of claim 14, wherein the searching the searchable user profiles by proficiency score to identify one or more one or more expert users with knowledge and proficiency in operating the particular component of the business application is in response to a user's request on a user-application interface for help in operating the particular component of the business application.

17. The computer-implemented method of claim 14, further comprising:
detecting repeated failure of a user to operate the business application properly; and
generate and provide a notification to the user to seek help.

18. A computer program product embodied in non-transitory computer-readable media carrying executable code, which code when executed:
tracks over time users' operation of individual components of a business application;
stores tracking data on ways in which different users operate individual components of the business application over time in a user history database;
evaluates the tracking data stored in the user history database to determine each user's knowledge and proficiency in operating a particular component of the business application;
accordingly, assigns a proficiency score to each user for knowledge and proficiency in operating the particular component of the business application; and
identifies at least one expert who can provide peer support to a particular user in operating the particular component business application based on criteria including one or more of (1) an immediate availability of the expert, (2) ease with which the particular user is expected to contact and get help from the expert, (3) a measure of how closely the particular user is connected to the expert on a social network, (4) whether the connection is direct or indirect via one or more users, (5) a measure of a physical distance between the particular user and the expert, (6) whether the particular user and the expert are located in a same company building, same campus, same city or same country, and (7) time zone differences between the particular user and the expert's locations.

19. The computer program product of claim 18, wherein the code when executed:
publishes the users' proficiency scores for knowledge and proficiency in operating the particular component of the business application on a social network.

20. The computer program product of claim 19, wherein the code when executed:
searches user profiles on the social network by proficiency score to identify one or more expert users with knowledge and proficiency in operating the particular component of the business application.
